(19) United States
(12) Patent Application Publication
(10) Pub. No.: US 2009/0021495 A1
(43) Pub. Date: Jan. 22, 2009

(54) Communicating audio and writing using a smart pen computing system

(76) Inventors: Tracy L. Edgecomb, (US); Jim Marggraff, (US)

Correspondence Address: FENWICK & WEST LLP, SILICON VALLEY CENTER, 801 CALIFORNIA STREET, MOUNTAIN VIEW, CA, 94041, US

(21) Appl. No.: 12/129,541

(22) Filed: May 29, 2008

Related U.S. Application Data
(60) Provisional application No. 60/940,668, filed on May 29, 2007.

(51) Int. Cl. G06F 3/033

(52) U.S. Cl. 345/179

(57) ABSTRACT

In a pen-based computing system, audio data is recorded from a microphone on the smart pen, and synchronized writing gesture data is generated from a gesture signal. Unsynchronized writing gesture data may also be received from another gesture signal. The audio data and the synchronized writing gesture data include a time component, enabling them to be synchronized. Message recipient data is received and a message is composed including the unsynchronized writing gesture data, the audio data, and the synchronized writing gesture data. The message is sent to a destination computing system based on the message recipient data. At the destination computing system, a user requests to play the message. The unsynchronized writing gesture data is displayed to the user, and the audio data is played as the synchronized writing gesture data is animated in sync.

### CROSS REFERENCE TO RELATED APPLICATIONS

This application claims the benefit of U.S. Provisional Application No. 60/940,668, filed May 29, 2007, which is incorporated by reference in its entirety.

### BACKGROUND

This invention relates generally to pen-based computing systems, and more particularly to communicating synchronized text and audio in a message to a recipient.

The ability to send communications electronically is normally limited depending on the specific device being used to send the communication. Typical limitations involve the format of the communication and the ability to send different types of communication, such as writing, text, and audio. But people want to be able to communicate with others whenever and wherever an idea strikes them. For example, if someone wants to draw a map to their house and give verbal directions, or write out a list of topics and make a few comments related to each one, there is no easy way to deliver this information to someone else who is not present.

While it is possible to send text messages or leave voicemails using a cell phone, there is no convenient or direct way of sending someone a hand-written message, or of creating mixed-media (e.g., writing plus audio) messages. Often, such as when explaining a difficult concept to another, words alone and audio alone are not sufficient.

Accordingly, there is a need for methods of communication that can more effectively present text and audio to a recipient.

### SUMMARY

Embodiments of the invention provide a system, method, and computer program product for communicating audio and writing using a smart pen. Unsynchronized writing gesture data is generated from a first gesture signal received from a gesture capture system on the smart pen. Audio data is recorded from a microphone on the smart pen, and synchronized writing gesture data is generated from a second gesture signal. The audio data and the synchronized writing gesture data include a time component, enabling them to be synchronized. Message recipient data is received and a message is composed including the unsynchronized writing gesture data, the audio data, and the synchronized writing gesture data. The message is sent to a destination computing system based on the message recipient data. At the destination computing system, a user requests to play the message. The unsynchronized writing gesture data is displayed to the user, and the audio data is played as the synchronized writing gesture data is animated in sync.

### BRIEF DESCRIPTION OF THE DRAWINGS

FIG. 1 is a schematic diagram of a pen-based computing system, in accordance with an embodiment of the invention.

FIG. 2 is a diagram of a smart pen for use in the pen-based computing system, in accordance with an embodiment of the invention.

FIG. 3 illustrates a method for communicating audio and writing, in accordance with an embodiment of the invention.

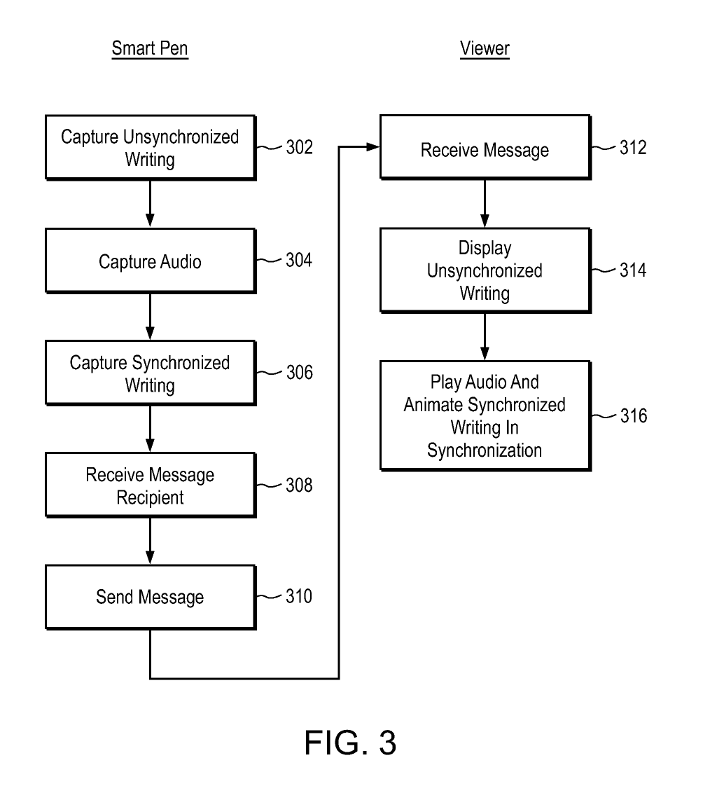

FIG. 4 illustrates an example use of an embodiment of a smart pen application for sending messages.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Pen-Based Computing System

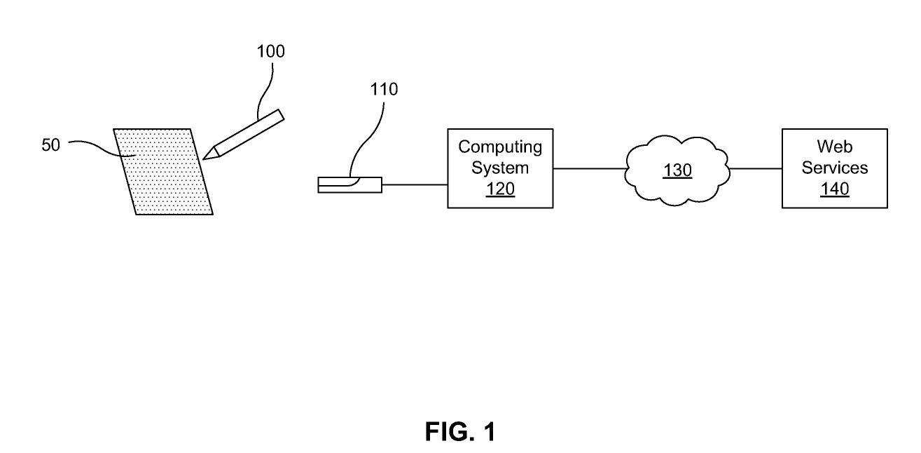

Embodiments of the invention may be implemented on various embodiments of a pen-based computing system, and other computing and/or recording systems. An embodiment of a pen-based computing system is illustrated in FIG. 1. In this embodiment, the pen-based computing system comprises a writing surface 50, a smart pen 100, a docking station 110, a client system 120, a network 130, and a web services system 140. The smart pen 100 includes onboard processing capabilities as well as input/output functionalities, allowing the pen-based computing system to expand the screen-based interactions of traditional computing systems to other surfaces on which a user can write. For example, the smart pen 100 may be used to capture electronic representations of writing as well as record audio during the writing, and the smart pen 100 may also be capable of outputting visual and audio information back to the user. With appropriate software on the smart pen 100 for various applications, the pen-based computing system thus provides a new platform for users to interact with software programs and computing services in both the electronic and paper domains.

In the pen based computing system, the smart pen 100 provides input and output capabilities for the computing system and performs some or all of the computing functionalities of the system. Hence, the smart pen 100 enables user interaction with the pen-based computing system using multiple modalities. In one embodiment, the smart pen 100 receives input from a user, using multiple modalities, such as capturing a user's writing or other hand gesture or recording audio, and provides output to a user using various modalities, such as displaying visual information or playing audio. In other embodiments, the smart pen 100 includes additional input modalities, such as motion sensing or gesture capture, and/or additional output modalities, such as vibrational feedback.

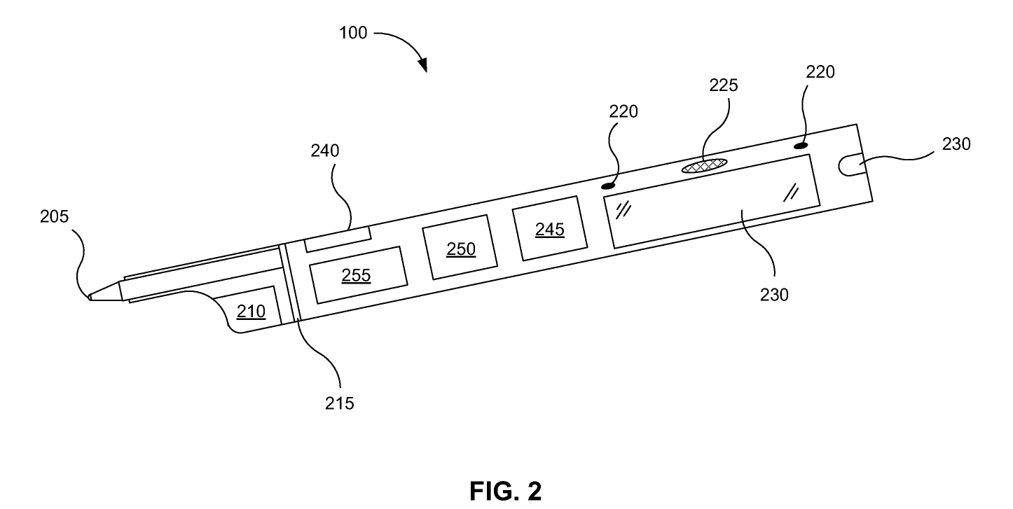

The components of a particular embodiment of the smart pen 100 are shown in FIG. 2 and described in more detail in the accompanying text. The smart pen 100 preferably has a form factor that is substantially shaped like a pen or other writing implement, although certain variations on the general shape may exist to accommodate other functions of the pen, or may even be an interactive multi-modal non-writing implement. For example, the smart pen 100 may be slightly thicker than a standard pen so that it can contain additional components, or the smart pen 100 may have additional structural features (e.g., a flat display screen) in addition to the structural features that form the pen shaped form factor. Additionally, the smart pen 100 may also include any mechanism by which a user can provide input or commands to the smart pen computing system or may include any mechanism by which a user can receive or otherwise observe information from the smart pen computing system.

The smart pen 100 is designed to work in conjunction with the writing surface 50 so that the smart pen 100 can capture writing that is made on the writing surface 50. In one embodiment, the writing surface 50 comprises a sheet of paper (or any other suitable material that can be written upon) and is encoded with a pattern that can be read by the smart pen 100. An example of such a writing surface 50 is the so-called “dot-enabled paper” available from Anoto Group AB of Sweden (local subsidiary Anoto, Inc. of Waltham, Mass.), and described in U.S. Pat. No. 7,175,095, incorporated by reference herein. This dot-enabled paper has a pattern of dots encoded on the paper. A smart pen 100 designed to work with this dot enabled paper includes an imaging system and a processor that can determine the position of the smart pen's writing tip with respect to the encoded dot pattern. This position of the smart pen 100 may be referred to using coordinates in a predefined “dot space,” and the coordinates can be either local (i.e., a location within a page of the writing surface 50) or absolute (i.e., a unique location across multiple pages of the writing surface 50).

In other embodiments, the writing surface 50 may be implemented using mechanisms other than encoded paper to allow the smart pen 100 to capture gestures and other written input. For example, the writing surface may comprise a tablet or other electronic medium that senses writing made by the smart pen 100. In another embodiment, the writing surface 50 comprises electronic paper, or e-paper. This sensing may be performed entirely by the writing surface 50 or in conjunction with the smart pen 100. Even if the role of the writing surface 50 is only passive (as in the case of encoded paper), it can be appreciated that the design of the smart pen 100 will typically depend on the type of writing surface 50 for which the pen based computing system is designed. Moreover, written content may be displayed on the writing surface 50 mechanically (e.g., depositing ink on paper using the smart pen 100), electronically (e.g., displayed on the writing surface 50), or not at all (e.g., merely saved in a memory). In another embodiment, the smart pen 100 is equipped with sensors to sensor movement of the pen's tip, thereby sensing writing gestures without requiring a writing surface 50 at all. Any of these technologies may be used in a gesture capture system incorporated in the smart pen 100.

In various embodiments, the smart pen 100 can communicate with a general purpose computing system 120, such as a personal computer, for various useful applications of the pen based computing system. For example, content captured by the smart pen 100 may be transferred to the computing system 120 for further use by that system 120. For example, the computing system 120 may include management software that allows a user to store, access, review, delete, and otherwise manage the information acquired by the smart pen 100. Downloading acquired data from the smart pen 100 to the computing system 120 also frees the resources of the smart pen 100 so that it can acquire more data. Conversely, content may also be transferred back onto the smart pen 100 from the computing system 120. In addition to data, the content provided by the computing system 120 to the smart pen 100 may include software applications that can be executed by the smart pen 100.

The smart pen 100 may communicate with the computing system 120 via any of a number of known communication mechanisms, including both wired and wireless communications. In one embodiment, the pen based computing system includes a docking station 110 coupled to the computing system. The docking station 110 is mechanically and electrically configured to receive the smart pen 100, and when the smart pen 100 is docked the docking station 110 may enable electronic communications between the computing system 120 and the smart pen 100. The docking station 110 may also provide electrical power to recharge a battery in the smart pen 100.

FIG. 2 illustrates an embodiment of the smart pen 100 for use in a pen based computing system, such as the embodiments described above. In the embodiment shown in FIG. 2, the smart pen 100 comprises a marker 205, an imaging system 210, a pen down sensor 215, one or more microphones 220, a speaker 225, an audio jack 230, a display 235, an I/O port 240, a processor 245, an onboard memory 250, and a battery 255. It should be understood, however, that not all of the above components are required for the smart pen 100, and this is not an exhaustive list of components for all embodiments of the smart pen 100 or of all possible variations of the above components. For example, the smart pen 100 may also include buttons, such as a power button or an audio recording button, and/or status indicator lights. Moreover, as used herein in the specification and in the claims, the term “smart pen” does not imply that the pen device has any particular feature or functionality described herein for a particular embodiment, other than those features expressly recited. A smart pen may have any combination of fewer than all of the capabilities and subsystems described herein.

The marker 205 enables the smart pen to be used as a traditional writing apparatus for writing on any suitable surface. The marker 205 may thus comprise any suitable marking mechanism, including any ink-based or graphite-based marking devices or any other devices that can be used for writing. In one embodiment, the marker 205 comprises a replaceable ballpoint pen element. The marker 205 is coupled to a pen down sensor 215, such as a pressure sensitive element. The pen down sensor 215 thus produces an output when the marker 205 is pressed against a surface, thereby indicating when the smart pen 100 is being used to write on a surface.

The imaging system 210 comprises sufficient optics and sensors for imaging an area of a surface near the marker 205. The imaging system 210 may be used to capture handwriting and gestures made with the smart pen 100. For example, the imaging system 210 may include an infrared light source that illuminates a writing surface 50 in the general vicinity of the marker 205, where the writing surface 50 includes an encoded pattern. By processing the image of the encoded pattern, the smart pen 100 can determine where the marker 205 is in relation to the writing surface 50. An imaging array of the imaging system 210 then images the surface near the marker 205 and captures a portion of a coded pattern in its field of view. Thus, the imaging system 210 allows the smart pen 100 to receive data using at least one input modality, such as receiving written input. The imaging system 210 incorporating optics and electronics for viewing a portion of the writing surface 50 is just one type of gesture capture system that can be incorporated in the smart pen 100 for electronically capturing any writing gestures made using the pen, and other embodiments of the smart pen 100 may use any other appropriate means for achieve the same function.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 50 (e.g., and not written using the smart pen 100). The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by a gesture capture system (e.g., the imaging system 210 in FIG. 2) in the smart pen 100. This technique may also be used to capture gestures, such as when a user taps the marker 205 on a particular location of the writing surface 50, allowing data capture using another input modality of motion sensing or gesture capture.

Another data capture device on the smart pen 100 are the one or more microphones 220, which allow the smart pen 100 to receive data using another input modality, audio capture. The microphones 220 may be used for recording audio, which may be synchronized to the handwriting capture described above. In an embodiment, the one or more microphones 220 are coupled to signal processing software executed by the processor 245, or by a signal processor (not shown), which removes noise created as the marker 205 moves across a writing surface and/or noise created as the smart pen 100 touches down to or lifts away from the writing surface. In an embodiment, the processor 245 synchronizes captured written data with captured audio data. For example, a conversation in a meeting may be recorded using the microphones 220 while a user is taking notes that are also being captured by the smart pen 100. Synchronizing recorded audio and captured handwriting allows the smart pen 100 to provide a coordinated response to a user request for previously captured data. For example, responsive to a user request, such as a written command, parameters for a command, a gesture with the smart pen 100, a spoken command or a combination of written and spoken commands, the smart pen 100 provides both audio output and visual output to the user. The smart pen 100 may also provide haptic feedback to the user.

The speaker 225, audio jack 230, and display 235 provide outputs to the user of the smart pen 100 allowing presentation of data to the user via one or more output modalities. The audio jack 230 may be coupled to earphones so that a user may listen to the audio output without disturbing those around the user, unlike with a speaker 225. Earphones may also allow a user to hear the audio output in stereo or full three-dimensional audio that is enhanced with spatial characteristics. Hence, the speaker 225 and audio jack 230 allow a user to receive data from the smart pen using a first type of output modality by listening to audio played by the speaker 225 or the audio jack 230.

The display 235 may comprise any suitable display system for providing visual feedback, such as an organic light emitting diode (OLED) display, allowing the smart pen 100 to provide output using a second output modality by visually displaying information. In use, the smart pen 100 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 100, and the display 235 may display word phrases, static or dynamic images, or prompts as directed by such an application. In addition, the speaker 225 and audio jack 230 may also be used to play back audio data that has been recorded using the microphones 220.

The input/output (I/O) port 240 allows communication between the smart pen 100 and a computing system 120, as described above. In one embodiment, the I/O port 240 comprises electrical contacts that correspond to electrical contacts on the docking station 110, thus making an electrical connection for data transfer when the smart pen 100 is placed in the docking station 110. In another embodiment, the I/O port 240 simply comprises a jack for receiving a data cable (e.g., Mini-USB or Micro-USB). Alternatively, the I/O port 240 may be replaced by a wireless communication circuit in the smart pen 100 to allow wireless communication with the computing system 120 (e.g., via Bluetooth, WiFi, infrared, or ultrasonic).

A processor 245, onboard memory 250, and battery 255 (or any other suitable power source) enable computing functionalities to be performed at least in part on the smart pen 100. The processor 245 is coupled to the input and output devices and other components described above, thereby enabling applications running on the smart pen 100 to use those components. In one embodiment, the processor 245 comprises an ARM9 processor, and the onboard memory 250 comprises a small amount of random access memory (RAM) and a larger amount of flash or other persistent memory. As a result, executable applications can be stored and executed on the smart pen 100, and recorded audio and handwriting can be stored on the smart pen 100, either indefinitely or until offloaded from the smart pen 100 to a computing system 120. For example, the smart pen 100 may locally stores one or more content recognition algorithms, such as character recognition or voice recognition, allowing the smart pen 100 to locally identify input from one or more input modality received by the smart pen 100.

In an embodiment, the smart pen 100 also includes an operating system or other software supporting one or more input modalities, such as handwriting capture, audio capture or gesture capture, or output modalities, such as audio playback or display of visual data. The operating system or other software may support a combination of input modalities and output modalities and manages the combination, sequencing and transitioning between input modalities (e.g., capturing written and/or spoken data as input) and output modalities (e.g., presenting audio or visual data as output to a user). For example, this transitioning between input modality and output modality allows a user to simultaneously write on paper or another surface while listening to audio played by the smart pen 100, or the smart pen 100 may capture audio spoken from the user while the user is also writing with the smart pen 100. Various other combinations of input modalities and output modalities are also possible.

In an embodiment, the processor 245 and onboard memory 250 include one or more executable applications supporting and enabling a menu structure and navigation through a file system or application menu, allowing launch of an application or of a functionality of an application. For example, navigation between menu items comprises a dialogue between the user and the smart pen 100 involving spoken and/or written commands and/or gestures by the user and audio and/or visual feedback from the smart pen computing system. Hence, the smart pen 100 may receive input to navigate the menu structure from a variety of modalities.

For example, a writing gesture, a spoken keyword, or a physical motion, may indicate that subsequent input is associated with one or more application commands. For example, a user may depress the smart pen 100 against a surface twice in rapid succession then write a word or phrase, such as “solve,” “send,” “translate,” “email,” “voice-email” or another predefined word or phrase to invoke a command associated with the written word or phrase or receive additional parameters associated with the command associated with the predefined word or phrase. This input may have spatial (e.g., dots side by side) and/or temporal components (e.g., one dot after the other). Because these “quick-launch” commands can be provided in different formats, navigation of a menu or launching of an application is simplified. The “quick-launch” command or commands are preferably easily distinguishable during conventional writing and/or speech.

Alternatively, the smart pen 100 also includes a physical controller, such as a small joystick, a slide control, a rocker panel, a capacitive (or other non-mechanical) surface or other input mechanism which receives input for navigating a menu of applications or application commands executed by the smart pen 100.

### Message Creation

To communicate according to an embodiment of the invention, a user writes or draws information on a writing surface 50, such as a piece of paper, using a smart pen 100. The user can add an audio message, some or all of which may be recorded by the microphone 220 of the smart pen while the user is writing on the paper. In one embodiment, the smart pen 100 includes two or more microphones 220 distributed along the smart pen, where the signals from the microphones can be used to perform noise cancellation on sounds from the pen and paper.

Beneficially, the capture of writing on the paper and the recording of audio may be synchronized by the smart pen 100. In one embodiment, the smart pen 100 synchronizes the writing capture by taking samples of position and time, (x, y, t), and the recorded audio is also sampled with reference to the same time, t. Alternatively, an audio recording may be recorded after the user writes on the paper; however, this loses the synchronization of the writing and audio or at least adds an additional synchronizing step. Additionally, audio that was recorded previously may be used as a foundation for a message (e.g., an introduction to the subject of the message) and incorporated into the message.

In one embodiment, the smart pen 100 allows the user to create a message that uses a combination of synchronized and unsynchronized audio recording. For example, the user may write a list of topics on the paper, then start recording audio, then add gestures and new notes while the audio is recording, and then end the message. The resulting message could then be presented as an animation that starts with the writing that was entered before the audio recording began. The animation would then continue by playing the recorded audio in synch with the writing that was entered during the audio recording. This may be particularly beneficial for complex notes that involve a lot of writing, as people tend to speak significantly faster than they can write.

Moreover, the smart pen 100 may allow a user to pause the audio recording and add additional notes anytime during the recording, rather than just adding writing before the audio recording starts. The resulting note may be an animation that begins with any writing that was added before the first audio recording, and then draws the user's writing in real time for anything that is written during the audio recording. At any points where the audio recording was paused and additional writing added, the playback would add that writing at the instant in time corresponding to when the audio recording was paused. By allowing users to pause the recording and write additional notes, the smart pen 100 enables a user to catch their writing up to their speaking for an animated note.

In one embodiment, the smart pen 100 includes a control mechanism to allow a user to erase written content that has been captured by the device. This control to erase may be defined by the user (e.g., by drawing a “delete” button and assigning that functionality thereto), predefined as a menu item accessible by the smart pen 100, or invoked via some other means. In one implementation, after a user has been writing with the smart pen 100, the user invokes the erase functionality and then defines the region of written content to be erased (e.g., by tapping opposite corners to define a rectangle to be erased, circling the content to be deleted, or performing some other input to define the region that encompasses the ink to be deleted). The smart pen 100 then deletes the selected written content from its memory or otherwise marks it not to be included with the captured content, e.g., when the smart pen is docked.

A message may be written on one or multiple pieces or types of writing surfaces 50. Previously-written information can be tagged to be included in the message. For example, the user may have previously written on another sheet of paper, and this writing could be stored on the smart pen 100. Within the smart pen 100 application that allows for the communication features described herein, the user may invoke an attach function, which would then prompt the user to select, e.g., opposite corners of a box that contains the writing. The user could then make the appropriate selections to define a box around the writing on the other piece of paper that the user desires to attach, and the smart pen computing system 100 would attach the writing from its memory 250 that is associated with the selected area to the communication. The user may also select a metatag that relates to a particular section and send that. For example, by selecting the title of a previous note session (written in a prespecified title field), all notes that fall within that session are selected.

In one embodiment, data existing on the smart pen 100 may also be marked for inclusion in the message. For example, the user can select a list of items that is stored in a list-making program. When the message is sent, the list is appended to the message. The user may also attach files or other applications (e.g., a calculator application) to the message, or the smart pen application may automatically attach other smart pen applications that were invoked on the paper (e.g., a calculator application) or applications related to content on the paper (e.g., a calendar application, where the calendar entry was referenced on the paper).

The application may be used to add subject line to the messages sent. A default subject may be in place, and a user may edit the default subject as desired. An example subject line may be: “A message for you from [name of user].”

If sent as an email or similar electronic message, the message may be added as an attachment. In such a case, the application may use a standard body text that will appear inside each message sent, and users may be able to edit this standard message. An example default message body text may be: “This message was sent to you from [name of user] with the [name of Pen] media pen. Click on the attachment to listen to your voice message. For more information on the [name of Pen] or to download a free interactive media player, visit www.livescribe.com.”

### Sending the Message

Once the user adds any desired writing and/or audio content to the message, the user may send the message. The user may specify the destination of the message using the smart pen 100, such as by writing an email address, by selecting a destination from an on-pen menu system that uses a combination of audio and visual feedback, or by writing a nickname that has been previously associated with an email address or with a set of email addresses. The audio feedback can be provided by a speaker 225 and the visual feedback can be provided by a display 235 on the pen. In one embodiment, the user speaks the destination information, such as a recipient's name, into the microphone 220, and the smart pen determines the destination using voice recognition technology. Alternatively, the destination may be specified using a related system, such as an attached personal computer 120. However, selecting the destination using the smart pen 100 and without requiring a computer would typically provide more flexibility, as the entire message could be prepared and transmitted using pen and paper alone.

Depending on the application, the user may signal the end of the message using several techniques. For example, the user may expressly end the message using a command defined in the smart pen application. Alternatively, the message may be sent as soon as a recipient is specified and the smart pen 100 is either docked or otherwise able to transmit the message (e.g., within a wireless network).

The user can select the intended recipient of the message from a list of previous recipients. The user can write out an email address or nickname of the intended recipient using the smart pen 100. The user can leave off the recipient, and will be prompted for it later by the application. The user can have copies of all messages sent to themselves as well as to the recipient. The message can be sent immediately, via wireless connectivity. The message can be transferred via BlueTooth or other short-range system to another device, such as a cell phone, and forwarded from there. The message can be saved for delayed delivery. The message can be transferred to an attached computing system 120 such as a desktop computer when the pen device 100 is docked or otherwise connected to the desktop computer. The message can be sent as an email attachment to the recipient. The message can be posted to a public or private web-accessible site. The audio and/or written information can be provided as separate attachments to the message. The messages may be sent using the user's email account or directly via a server operated by a service provider. In one embodiment, the message is sent in real time (i.e., as it is being composed). Audio and handwriting can be combined for a real time transmission.

### Viewing the Message

Upon delivery of the message, a recipient may view the message in a user interface to see the writing and audio content contained therein. In one embodiment, the message can be viewed as an animated video, where the recorded audio plays back while the written information animates onto the screen synchronized with the audio as it was when it was recorded. The animated message may be viewed, for example, by the general purpose computing system 120 running a standard viewer software (such as when the message is in a standard format, such as Flash, Window Media Player, QuickTime, PDF, etc.) or a proprietary software. The proprietary software may be required to enable some of the special features beyond mean animation of audio and writing (such as attachment of smart pen applications or special playback features). The special proprietary viewing software may can be downloaded for free from a service provider or seller of the smart pen or smart pen application. The message can be viewed on a personal computer, or using any other device capable of presenting the visual and audio information (e.g., cellular phone, PDA, television, etc.).

Additionally, the recipient may access the information in a different modality than that with which it was originally sent. For example, if a recipient of a message is in a meeting and cannot listen to the message, the recipient can choose to have the spoken message converted to text by a human-based or computer-based system. In another example, if the recipient is driving a car but wants to access a message that was sent in handwriting, the recipient can choose to have the handwriting converted to speech through a human-based or computer-based system. Also, with messages that include both audio and handwriting/text, the recipient may choose to access the message using only one of the two modalities the message was originally recorded in.

### Example Use

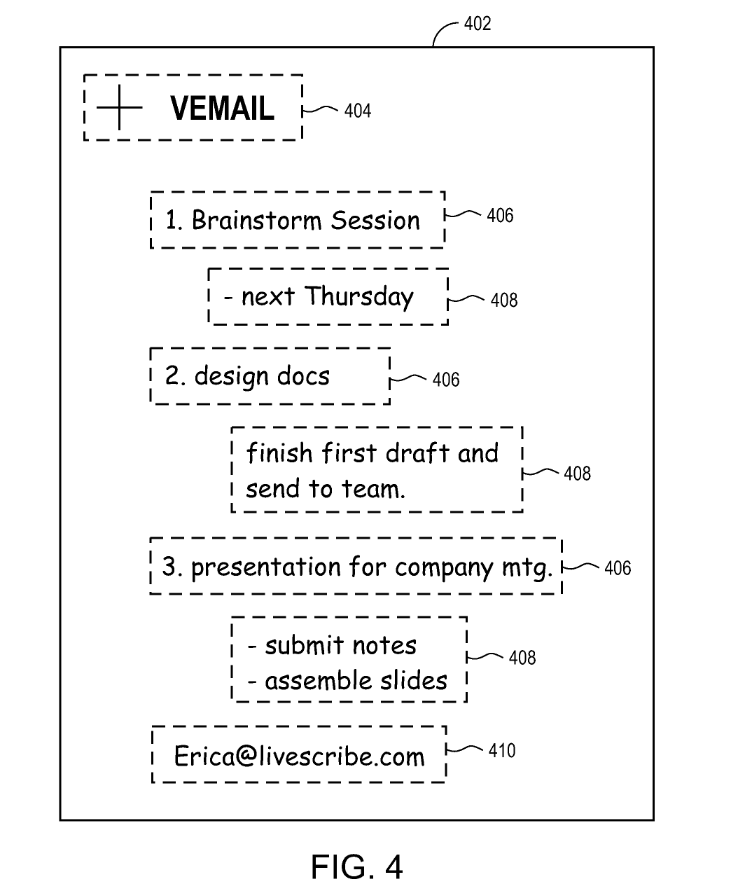

FIG. 4 illustrates an example use of an embodiment of a smart pen application for sending messages. FIG. 4 depicts the paper 402 on which the sender would write a sample message. The paper is a type of writing surface 50.

The user first invokes a messaging program, which in this example is a smart pen application called “VEmail.” The user draws an input cross in the upper left corner of the paper 402 for use to enter control information for the smart pen application. This is illustrated in region 404 of the paper 402. In response to invoking the VEmail application, the smart pen computing system 100 may play a sound or display a visual instruction: “Write your message. Double-tap when finished.” The sound is played through a speaker 225 and the visual instruction is displayed through the display 235.

The user then writes some information on the paper 402, such as the list of three items 406. In this example, the user writes only the three enumerated items in the list, and the writing immediately below each enumerated list item (e.g., the “next Thursday” below the first item) is not written at this time. Anytime during this process, the user may cancel and exit the application, e.g., by tapping “left” on the input cross. (Tapping left may be accomplished by touching the pen device on the left extension of the cross.)

If the user double-taps to indicate that the initial writing is complete (double-tapping can be accomplished by pressing the pen 100 anywhere to the paper twice in succession), the user is then prompted, either visually or via audio, to: “Record message at the beep. Double-tap when finished.” The user then records an audio message with reference to the three listed items. The audio can be recorded by the microphone 220 of the smart pen 100. While recording the audio message, the user may add to the writing on the paper 402, such as the additional information 408 written below each enumerated item (e.g., the “next Thursday” below the first item). The user then double-taps to stop the recording.

To specify the recipient, the user may then write the name of the destination (such as an email address), or the user may select the recipient from a list. In the example in FIG. 4, the user writes the destination email address 410 on the paper 402 with the smart pen 100. In one example, the user may navigate through an address list by inputting up, down, left, and right controls on the input cross in region 404 and by receiving audio and/or visual feedback from the speaker 225 and display 235 of the smart pen. When the user docks the device, the message is then sent to the specified destination.

At the destination, the recipient of the message may play the message as described above. In this example, the playback of the message would begin with a display of the three listed items. As the recorded audio plays, the additional written content would be animated along with the recorded audio, synchronized and presented in the way it was recorded. Or, as noted above, the recipient may choose to convert the message from the medium it was originally recorded in to a different medium for playback.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer program product for communicating audio and writing using a smart pen, the computer program product comprising a computer-readable storage medium containing computer program code for:
generating audio data on the smart pen from an audio signal received by an audio input on the smart pen;
generating synchronized writing gesture data on the smart pen from a first gesture signal received by a gesture capture system on the smart pen, the synchronized writing gesture data being substantially synchronized with the audio data;
receiving message recipient data;
composing a message comprising the audio data and the synchronized writing gesture data; and
sending the message to a destination computing system based on the message recipient data.

2. The computer program product of claim 1, wherein the message recipient data is received from an input device on the smart pen.

3. The computer program product of claim 1, wherein the message recipient data is generated from a second gesture signal received from the gesture capture system on the smart pen.

4. The computer program product of claim 1, wherein the message recipient data is received from an attached personal computer.

5. The computer program product of claim 1, further comprising computer program code for:
displaying message recipient data on a display of the smart pen.

6. The computer program product of claim 1, further comprising computer program product code for:
generating unsynchronized writing gesture data from a second gesture signal received from the gesture capture system on the smart pen.

7. The computer program product of claim 1, further comprising computer program code for:
generating paused writing gesture data from a second gesture signal received from the gesture capture system of the smart pen while the audio data generation is paused, the paused writing gesture data being associated with a single point in time.

8. The computer program product of claim 1, wherein the message recipient data comprises an email address.

9. The computer program product of claim 1, further comprising computer program code for:
receiving a selection for audio data and synchronized writing gesture data previously captured and stored in a memory of the smart pen; and
including the selected data in the message.

10. The computer program product of claim 1, wherein the synchronized writing gesture data spans multiple pages.

11. The computer program product of claim 1, wherein the message is composed on the smart pen.

12. The computer program product of claim 1, wherein the audio input on the smart pen comprises a plurality of microphones.

13. A computer program product for displaying audio and writing recorded using a smart pen, the computer program product comprising a computer-readable storage medium containing computer program code for:
receiving a message containing:
audio data comprising audio recorded by the smart pen, and
synchronized writing gesture data comprising writing gestures captured by the smart pen, the synchronized writing gesture data being synchronized with the audio data; and
responsive to a user request to play the message:
animating the synchronized writing gesture data, and
playing the audio data in synchronization with the animating of the synchronized writing gesture data.

14. The computer program product of claim 13, wherein the message is an email attachment.

15. A pen-based computing system for capturing and displaying writing and audio, the system comprising:
a smart pen device comprising:
a microphone configured to record audio and produce audio data based thereon,
a gesture capture system configured to capture writing gestures made with the smart pen device,
a processor configured to associate writing gestures made during the recording of audio and produce synchronized writing gesture data based thereon,
a storage medium,
instructions contained on the storage medium and capable of being executed by the processor, the instructions for sending a message to a destination computer system, the message comprising the audio data and the synchronized writing gesture data, the destination computing system based at least in part on message recipient data; and

16. The pen-based computing system of claim 15, further comprising:
a computer program product for playing back the message on the destination computer system, the computer program product comprising a computer-readable storage medium containing computer program code for:
receiving the message; and
animating the synchronized writing gesture data and playing the audio data in synchronization.

17. The pen-based computing system of claim 15, wherein the message recipient data is received from an input device on the smart pen.

18. The pen-based computing system of claim 15, wherein the message recipient data is generated from the writing gestures made with the smart pen device.

19. The pen-based computing system of claim 15, wherein the message is sent as an email attachment.

20. The pen-based computing system of claim 15, wherein the instructions are further configured for displaying message recipient data on a display of the smart pen device.
